(19) United States
(12) Patent Application Publication
(10) Pub. No.: US 2025/0237557 A1
(43) Pub. Date: Jul. 24, 2025

(54) SENSOR

(71) Applicant: KABUSHIKI KAISHA TOSHIBA, Tokyo (JP)

(72) Inventors: Yoshihiko KURUI, Chigasaki Kanagawa (JP); Yosuke AKIMOTO, Yokohama Kanagawa (JP)

(73) Assignee: KABUSHIKI KAISHA TOSHIBA, Tokyo (JP)

(21) Appl. No.: 19/008,840

(22) Filed: Jan. 3, 2025

(30) Foreign Application Priority Data
Jan. 24, 2024 (JP) 2024-008919

(51) Int. Cl. G01K 7/01; G01K 1/02; G01K 7/02; G01K 7/16

(52) U.S. Cl. CPC G01K 7/01; G01K 1/026; G01K 7/02; G01K 7/16

(57) ABSTRACT

According to one embodiment, a sensor includes a base, a first detection section, and a second detection section. The base includes a first base region and a second base region. The first detection section includes a first fixed portion fixed to the first base region, a first temperature detection element fixed to the first base region, and a first element supported by the first fixed portion. A first gap is provided between the first temperature detection element and the first element. The first element includes a first resistance member and a first conductive member. At least a part of the first temperature detection element overlaps the first element in a first direction from the first base region to the first fixed portion. The second detection section includes a second fixed portion fixed to the second base region, and a second element supported by the second fixed portion.

### CROSS-REFERENCE TO RELATED APPLICATIONS

This application is based upon and claims the benefit of priority from Japanese Patent Application No. 2024-008919, filed on Jan. 24, 2024; the entire contents of which are incorporated herein by reference.

### FIELD

Embodiments described herein relate generally to a sensor.

### BACKGROUND

For example, there are sensors using MEMS (Micro Electro Mechanical Systems) elements. Stable detection is desired in sensors.

### BRIEF DESCRIPTION OF THE DRAWINGS

FIGS. 1A and 1B are schematic cross-sectional views illustrating a sensor according to the first embodiment;

FIG. 2 is a schematic plan view illustrating the sensor according to the first embodiment; and

FIGS. 3A and 3B are schematic cross-sectional views illustrating a sensor according to the first embodiment.

### DETAILED DESCRIPTION

According to one embodiment, a sensor includes a base, a first detection section, and a second detection section. The base includes a first base region and a second base region. The first detection section includes a first fixed portion fixed to the first base region, a first temperature detection element fixed to the first base region, and a first element supported by the first fixed portion. A first gap is provided between the first temperature detection element and the first element. The first element includes a first resistance member and a first conductive member. At least a part of the first temperature detection element overlaps the first element in a first direction from the first base region to the first fixed portion. The second detection section includes a second fixed portion fixed to the second base region, and a second element supported by the second fixed portion. A second gap is provided between the second base region and the second element. The second element includes a second resistance member.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

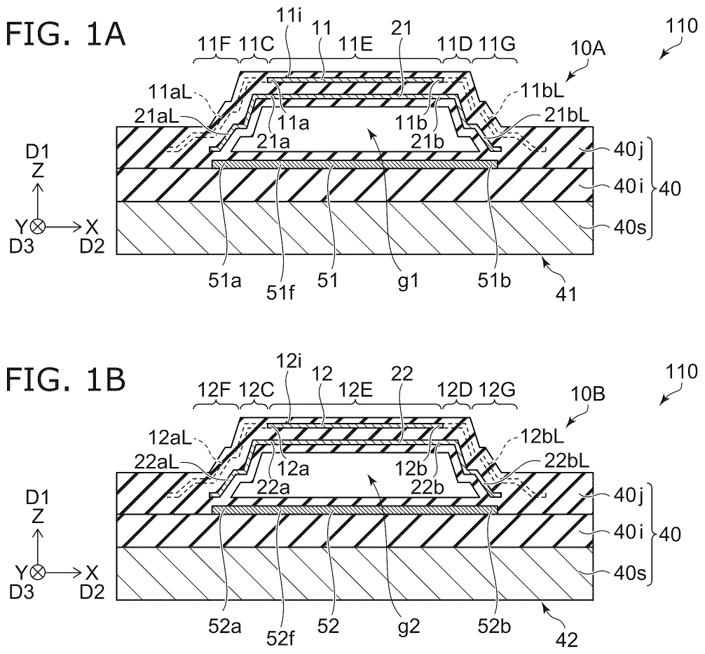

FIGS. 1A and 1B are schematic cross-sectional views illustrating a sensor according to the first embodiment.

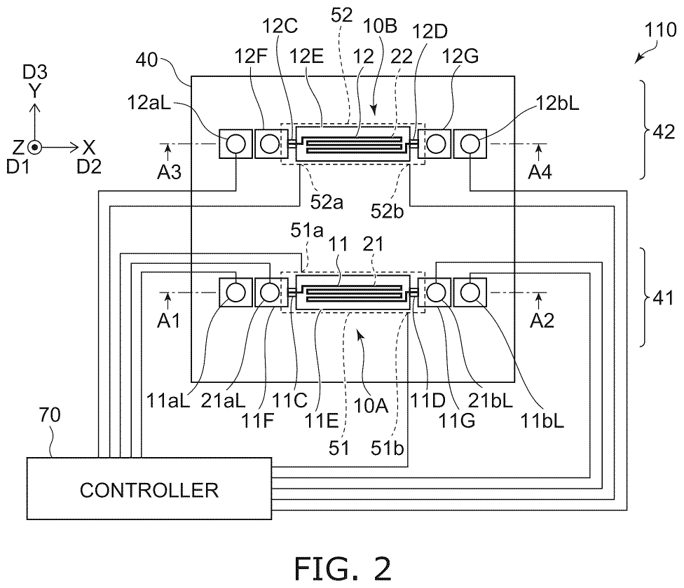

FIG. 2 is a schematic plan view illustrating the sensor according to the first embodiment.

FIG. 1A is a sectional view taken along the line A1-A2 in FIG. 2. FIG. 1B is a sectional view taken along the line A3-A4 in FIG. 2.

As shown in FIGS. 1A, 1B, and 2, a sensor 110 according to the embodiment includes a base 40, a first detection section 10A, and a second detection section 10B.

The base 40 includes a first base region 41 and a second base region 42. The first detection section 10A is provided on the first base region 41. The second detection section 10B is provided on the second base region 42. The region where the first detection section 10A is provided corresponds to the first base region 41. The region where the second detection section 10B is provided corresponds to the second base region 42. The boundaries of these substrate regions may be clear or unclear.

The first detection section 10A includes a first fixed portion 11F, a first temperature detection element 51, and a first element 11E. The first fixed portion 11F is fixed to the first base region 41. The first temperature detection element 51 is fixed to the first base region 41. The first element 11E is supported by the first fixed portion 11F. A first gap g1 is provided between the first temperature detection element 51 and the first element 11E. The first element 11E includes a first resistance member 11 and a first conductive member 21. The first element 11E is, for example, a first film portion. The first conductive member 21 is, for example, a heater.

A first direction D1 from the first base region 41 to the first fixed portion 11F is defined as a Z-axis direction. One direction perpendicular to the Z-axis direction is defined as an X-axis direction. A direction perpendicular to the Z-axis direction and the X-axis direction is defined as a Y-axis direction. The direction from the first base region 41 to the second base region 42 crosses the first direction D1.

In the first direction D1 from the first base region 41 to the first fixed portion 11F, at least a part of the first temperature detection element 51 overlaps the first element 11E.

The second detection section 10B includes a second fixed portion 12F and a second element 12E. The second fixed portion 12F is fixed to the second base region 42. The second element 12E is supported by the second fixed portion 12F. A second gap g2 is provided between the second base region 42 and the second element 12E. The second element 12E includes the second resistance member 12. The second element 12E is, for example, a second film portion.

For example, as shown in FIG. 2, the sensor 110 may include a controller 70. The controller 70 is electrically connected to the first resistance member 11, the first conductive member 21, the second resistance member 12, and the first temperature detection element 51. The controller 70 may be configured to perform the following first operation. In the first operation, the controller 70 detects a detection value corresponding to a difference between a first electrical resistance of the first resistance member 11 and a second electrical resistance of the second resistance member 12 after power is supplied to the first conductive member 21.

For example, pulsed power is supplied to the first conductive member 21. By the electric power being supplied to the first conductive member 21, the temperature of the first element 11E is increased. After this, the temperature of the first element 11E changes (decreases) toward the original temperature. At this time, the heat propagation characteristics change depending on the detection target (for example, gas) that exists around the first element 11E. The temperature of the first element 11E has a value depending on the detection target. Therefore, the first electrical resistance of the first resistance member 11 depends on the state of the detection target (type, concentration, flow rate, etc.). On the other hand, no power is supplied to the second element 12E, and the temperature of the second element 12E is substantially constant. The detection target can be detected by detecting a value corresponding to the difference between the first electrical resistance of the first element 11E and the second electrical resistance of the second element 12E.

In the embodiment, a first temperature detection element 51 is provided. The first temperature detection element 51 detects the temperature around the first element 11E (for example, the temperature of the first base region 41). By correcting the above-mentioned “detected value corresponding to the difference” using the first temperature detected by the first temperature detection element 51, the detection target can be detected with higher accuracy.

Thus, in the first operation, the controller 70 outputs a first correction value obtained by correcting the detected value using a first value corresponding to the first temperature detected by the first temperature detection element 51. For example, in the first operation, the controller 70 is configured to detect the detection target substance around the first element 11E by correcting the detected value using the first value corresponding to the first temperature detected by the first temperature detection element 51.

In the embodiment, at least a part of the first temperature detection element 51 overlaps the first element 11E in the first direction D1. Thereby, the temperature-based correction based on the temperature can be performed with higher accuracy.

For example, a first reference example may be considered in which the first temperature detection element 51 is provided at a different position from the first element 11E. In the first reference example, the first temperature detection element 51 is provided at a position different from the first base region 41. The temperature detected by the first temperature detection element 51 does not necessarily reflect the temperature of the first element 11E. For example, the temperature change detected by the first temperature detection element 51 provided at a position away from the first element 11E may be delayed in time with respect to the temperature change of the first element 11E. Therefore, in the first reference example, highly accurate correction is difficult.

In the embodiment, at least a part of the first temperature detection element 51 overlaps the first element 11E in the first direction D1. The heat of the first element 11E is efficiently transmitted to the first temperature detection element 51 via the first gap g1. For example, time delays in temperature changes can be suppressed.

For example, the heat of the first element 11E is transmitted to the base 40 via the first fixed portion 11F. Changes in temperature due to heat conduction via the first fixed portion 11F are efficiently detected by the first temperature detection element 51. Detection with higher accuracy is possible.

In this example, the first detection section 10A further includes a first connecting portion 11C. The first connecting portion 11C is provided between the first fixed portion 11F and the first element 11E. The first connecting portion 11C is supported by the first fixed portion 11F. The first connecting portion 11C supports the first element 11E. A part of the first gap g1 is provided between the first base region 41 and the first connecting portion 11C.

For example, a part of the first temperature detection element 51 may overlap at least a part of the first connecting portion 11C in the first direction D1. A change in temperature caused by the first connecting portion 11C can be detected more efficiently by the first temperature detection element 51.

A second direction D2 from the first fixed portion 11F to the first element 11E crosses the first direction D1. The second direction D2 may be, for example, the X-axis direction. A width of the first connecting portion 11C in a cross direction crossing an extending direction (second direction D2) of the first connecting portion 11C is smaller than a width of the first element 11E in the cross direction. Thereby, for example, the heat of the first element 11E is suppressed from being radiated to the base 40 via the first connecting portion 11C. Detection with higher accuracy is possible. The crossing direction may be along a third direction D3 crossing a plane including the first direction D1 and the second direction D2. The third direction D3 is, for example, the Y-axis direction.

The first detection section 10A may further include a first other fixed portion 11G fixed to the first base region 41. A part of the first element 11E is further supported by the first other fixed portion 11G. In this example, the first detection section 10A further includes a first other connecting portion 11D. The first other connecting portion 11D is provided between the first other fixed portion 11G and the first element 11E. The first other connecting portion 11D is supported by the first other fixed portion 11G. The first other connecting portion 11D supports the first element 11E. A part of the first gap g1 is provided between the first base region 41 and the first other connecting portion 11D. The first element 11E is provided between the first connecting portion 11C and the first other connecting portion 11D.

In this example, the second detection section 10B further includes a second connecting portion 12C. The second connecting portion 12C is provided between the second fixed portion 12F and the second element 12E. The second connecting portion 12C is supported by the second fixed portion 12F. The second connecting portion 12C supports the second element 12E. A part of the second gap g2 is provided between the second base region 42 and the second connecting portion 12C.

A width of the second connecting portion 12C in the cross direction crossing an extending direction of the second connecting portion 12C is smaller than a width of the second element 12E in the cross direction.

The second detection section 10B may further include a second other fixed portion 12G fixed to the second base region 42. A part of the second element 12E is further supported by the second other fixed portion 12G. In this example, the second detection section 10B further includes a second other connecting portion 12D. The second other connecting portion 12D is provided between the second other fixed portion 12G and the second element 12E. The second other connecting portion 12D is supported by the second other fixed portion 12G. The second other connecting portion 12D supports the second element 12E. A part of the second gap g2 is provided between the second base region 42 and the second other connecting portion 12D. The second element 12E is provided between the second connecting portion 12C and the second other connecting portion 12D.

The second element 12E may further include a second conductive member 22. The configuration of the second conductive member 22 may be substantially the same as the configuration of the first conductive member 21. By providing the second conductive member 22, for example, the thermal characteristics (e.g., heat capacity, etc.) of the second element 12E can be made substantially the same as the thermal characteristics of the first element 11E. Correction using the second element 12E can be performed with higher accuracy.

Power does not need to be supplied to the second conductive member 22. The controller 70 does not need to be connected to the second conductive member 22. The second conductive member 22 does not have to be used for the operation.

In this example, the second detection section 10B further includes a second temperature detection element 52 fixed to the second base region 42. The second gap g2 is provided between the second temperature detection element 52 and the second element 12E. In the first direction D1, at least a part of the second temperature detection element 52 overlaps the second element 12E.

As shown in FIG. 2, the controller 70 may be is electrically connected to the first resistance member 11, the first conductive member 21, the second resistance member 12, the first temperature detection element 51, and the second temperature detection element 52. The controller 70 may be configured to perform the following second operation. In the second operation, the controller 70 detects a detection value corresponding to a difference between the first electrical resistance of the first resistance member 11 and the second electrical resistance of the second resistance member 12 after power is supplied to the first conductive member 21. In the second operation, the controller 70 outputs a first correction value obtained by correcting the detection value using at least one of a first value corresponding to the first temperature detected by the first temperature detection element 51 and a second value corresponding to the second temperature detected by the second temperature detection element 52.

For example, in the second operation, the controller 70 corrects the detection value using at least one of the first value corresponding to the first temperature detected by the first temperature detection element 51 and the second value corresponding to the second temperature detected by the second temperature detection element 52, and detects the detection target substance around the first element.

In the embodiment, a part of the second temperature detection element 52 may overlap at least a part of the second fixed portion 12F in the first direction D1.

As already explained, the second detection section 10B may further include the second connecting portion 12C. A part of the second temperature detection element 52 may overlap at least a part of the second connecting portion 12C in the first direction D1. The second detection section 10B may further include the second other connecting portion 12D. A part of the second temperature detection element 52 may overlap at least a part of the second other connecting portion 12D in the first direction D1.

As shown in FIG. 1A, the first element 11E may include a first insulating member 11i. The first insulating member 11i is provided around the first resistance member 11 and the first conductive member 21. As shown in FIG. 1B, the second element 12E may include a second insulating member 12i. The second insulating member 12i is provided around the second resistance member 12 and the second conductive member 22.

As shown in FIG. 1A, a first resistance wiring 11aL connected to a part 11a of the first resistance member 11 may pass through the first fixed portion 11F. A first other resistance wiring 11bL connected to another part 11b of the first resistance member 11 may pass through the first other fixed portion 11G. A first conductive wiring 21aL connected to a part 21a of the first conductive member 21 may pass through the first fixed portion 11F. A first other conductive wiring 21bL connected to another part 21b of the first conductive member 21 may pass through the first other fixed portion 11G.

As shown in FIG. 1B, a second resistance wiring 12aL connected to a part 12a of the second resistance member 12 may pass through the second fixed portion 12F. A second other resistance wiring 12bL connected to another part 12b of the second resistance member 12 may pass through the second other fixed portion 12G. A second conductive wiring 22aL connected to a part 22a of the second conductive member 22 may pass through the second fixed portion 12F. A second other conductive wiring 22bL connected to another part 22b of the second conductive member 22 may pass through the second other fixed portion 12G.

As shown in FIG. 2, the controller 70 may be electrically connected to the first resistance wiring 11aL and the first other resistance wiring 11bL. The controller 70 may be electrically connected to the first conductive wiring 21aL and the first other conductive wiring 21bL. The controller 70 may be electrically connected to the second resistance wiring 12aL and the second other resistance wiring 12bL.

As shown in FIG. 2, the controller 70 may be electrically connected to a part 51a of the first temperature detection element 51 and another part 51b of the first temperature detection element 51. The controller 70 may be electrically connected to a part 52a of the second temperature detection element 52 and another part 52b of the second temperature detection element 52.

As described above, at least one of the first resistance wiring 11aL electrically connected to the first resistance member 11 and the first conductive wiring 21aL electrically connected to the first conductive member 21 may pass through the first fixed portion 11F. In such a configuration, heat of the first element 11E is likely to propagate through these wirings. In such a case, since the first temperature detection element 51 overlaps the first fixed portion 11F, the temperature state of the first element 11E can be detected with higher accuracy. It is possible to perform correction with higher accuracy.

As shown in FIGS. 1A and 1B, the base 40 may include a substrate 40s and an insulating layer 40i. The substrate 40s may be, for example, a semiconductor substrate (such as a silicon substrate). The insulating layer 40i is provided on the substrate 40s. In one example, the first temperature detection element 51 and the second temperature detection element 52 may be provided on the insulating layer 40i. The insulating layer 40i may include, for example, silicon oxide.

As shown in FIGS. 1A and 1B, the sensor 110 may further include a first insulating film 40j. The first insulating film 40j is provided between the first temperature detection element 51 and the first element 11E. For example, the first insulating film 40j is in contact with the first temperature detection element 51. The first gap g1 is provided between the first insulating film 40j and the first element 11E. The first insulating film 40j protects the first temperature detection element 51. The first insulating film 40j may include, for example, silicon nitride.

As shown in FIG. 1A, the first temperature detection element 51 may include a first conductive layer 51f. For example, the electrical resistance of the first conductive layer 51f changes depending on the temperature. As shown in FIG. 1B, the second temperature detection element 52 may include a second conductive layer 52f. For example, the electrical resistance of the second conductive layer 52f changes depending on the temperature.

At least one of the first conductive layer 51f or the second conductive layer 52f includes, for example, at least one selected from the group consisting of a metal layer and a semiconductor. The metal layer includes, for example, at least one selected from the group consisting of TIN, Al, Cu, and AlCu.

At least one of the first conductive layer 51f or the second conductive layer 52f may include polysilicon, for example. At least one of the first conductive layer 51f or the second conductive layer 52f may include, for example, a pn junction. At least one of the first conductive layer 51f or the second conductive layer 52f may include, for example, a thermocouple.

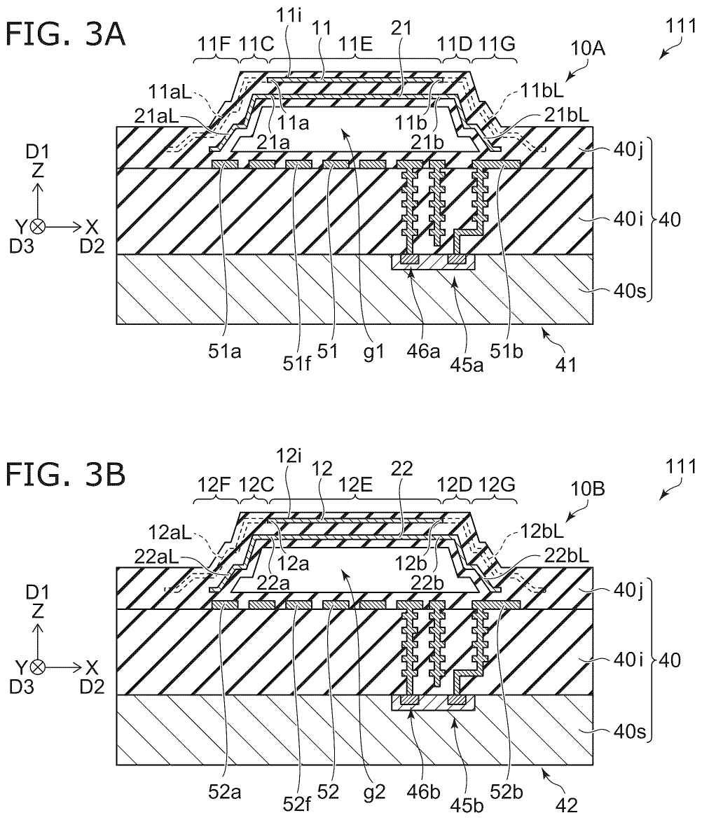

FIGS. 3A and 3B are schematic cross-sectional views illustrating a sensor according to the first embodiment.

As shown in FIG. 3A, in a sensor 111 according to the embodiment, the configuration of the first temperature detection element 51 is different from the configuration of the first temperature detection element 51 in the sensor 110. The configuration of the sensor 111 except for this may be the same as the configuration of the sensor 110.

As shown in FIG. 3A, the base 40 (first base region 41) includes a first circuit 45a. The first circuit 45a is provided in the first base region 41. The first circuit 45a includes a first control element 46a. The first control element 46a includes, for example, a transistor. The first conductive layer 51f is electrically connected to the first control element 46a. The first control element 46a may include, for example, a CMOS (Complementary Metal Oxide Semiconductor). For example, the first conductive layer 51f may include the same material as the conductive film included in the first circuit 45a.

As shown in FIG. 3B, the base 40 includes a second circuit 45b. The second circuit 45b is provided in the second base region 42. The second circuit 45b includes a second control element 46b. The second control element 46b includes, for example, a transistor. The second conductive layer 52f is electrically connected to the second control element 46b. The second control element 46b may include, for example, CMOS. For example, the second conductive layer 52f may include the same material as the conductive film included in the second circuit 45b.

The first circuit 45a and the second circuit 45b may include at least a part of the circuit included in the controller 70, for example. The first circuit 45a and the second circuit 45b may include, for example, at least one of a gas detection circuit, a temperature detection circuit, a heater voltage generation circuit, and a control circuit.

In the embodiment, at least one of the first resistance member 11 or the second resistance member 12 may include at least one selected from the group consisting of, for example, TiN, Ti, W, Al, Cu, AlCu, Si, and Pd. At least one of the first conductive member 21 or the second conductive member 22 may include, for example, at least one selected from the group consisting of TIN, Ti, W, Al, Cu, AlCu, Si, and Pd. At least one of the first insulating member 11i or the second insulating member 12i may include silicon nitride, for example.

The embodiments may include the following Technical proposals:

### (Technical Proposal 1)

A sensor, comprising:
a base including a first base region and a second base region;
a first detection section; and
a second detection section,
the first detection section including:
   a first fixed portion fixed to the first base region,
   a first temperature detection element fixed to the first base region, and
   a first element supported by the first fixed portion,
a first gap being provided between the first temperature detection element and the first element,
the first element including a first resistance member and a first conductive member,
at least a part of the first temperature detection element overlapping the first element in a first direction from the first base region to the first fixed portion,
the second detection section including:
   a second fixed portion fixed to the second base region, and
   a second element supported by the second fixed portion,
a second gap being provided between the second base region and the second element, and
the second element including a second resistance member.

### (Technical Proposal 2)

The sensor according to Technical proposal 1, further comprising:
a controller electrically connected to the first resistance member, the first conductive member, the second resistance member, and the first temperature detection element,
the controller being configured to perform a first operation, and
in the first operation, the controller being configured to detect a detection value corresponding to a difference between a first electrical resistance of the first resistance member after power is supplied to the first conductive member and a second electrical resistance of the second resistance member, and the controller being configured to output a first correction value obtained by correcting the detection value using a first value corresponding to a first temperature detected by the first temperature detection element.

### (Technical Proposal 3)

The sensor according to Technical proposal 1, further comprising:
a controller electrically connected to the first resistance member, the first conductive member, the second resistance member, and the first temperature detection element,
the controller being configured to perform a first operation, and
in the first operation, the controller being configured to detect a detection value corresponding to a difference between a first electrical resistance of the first resistance member after power is supplied to the first conductive member and a second electrical resistance of the second resistance member, and the controller being configured to correct the detection value using a first value corresponding to a first temperature detected by the first temperature detection element to detect a detection target substance around the first element.

### (Technical Proposal 4)

The sensor according to Technical proposal 1, wherein
the second detection section further includes a second temperature detection element fixed to the second base region,
the second gap is provided between the second temperature detection element and the second element, and
in the first direction, at least a part of the second temperature detection element overlaps the second element.

### (Technical Proposal 5)

The sensor according to Technical proposal 4, further comprising:
a controller electrically connected to the first resistance member, the first conductive member, the second resistance member, the first temperature detection element, and the second temperature detection element,
the controller being configured to perform a second operation, and
in the second operation, the controller being configured to detect a detection value corresponding to a difference between a first electrical resistance of the first resistance member after power is supplied to the first conductive member and a second electrical resistance of the second resistance member, and the controller being configured to output a first correction value obtained by correcting the detection value using at least one of a first value corresponding to a first temperature detected by the first temperature detection element or a second value corresponding to a second temperature detected by the second temperature detection element.
   (Technical proposal 6)

The sensor according to Technical proposal 4, further comprising:
a controller electrically connected to the first resistance member, the first conductive member, the second resistance member, the first temperature detection element, and the second temperature detection element,
the controller being configured to perform a second operation,
in the second operation, the controller being configured to detect a detection value corresponding to a difference between a first electrical resistance of the first resistance member after power is supplied to the first conductive member and a second electrical resistance of the second resistance member, and the controller being configured to correct the detection value using at least one of a first value corresponding to a first temperature detected by the first temperature detection element or a second value corresponding to a second temperature detected by the second temperature detection element to detect a detection target substance around the first element.
   (Technical proposal 7)

The sensor according to any one of Technical proposals 4-6, wherein
a part of the second temperature detection element overlaps at least a part of the second fixed portion in the first direction.
   (Technical proposal 8)

The sensor according to any one of Technical proposals 4-6, wherein
the second detection section further includes a second connecting portion provided between the second fixed portion and the second element,
the second connecting portion is supported by the second fixed portion,
the second connecting portion supports the second element,
a part of the second gap is provided between the second base region and the second connecting portion, and
a part of the second temperature detection element overlaps at least a part of the second connecting portion in the first direction.

### (Technical Proposal 9)

The sensor according to any one of Technical proposals 1-8, wherein
a part of the first temperature detection element overlaps at least a part of the first fixed portion in the first direction.

### (Technical Proposal 10)

The sensor according to Technical proposal 9, wherein
at least one of a first resistance wiring electrically connected to the first resistance member or a first conductive wiring electrically connected to the first conductive member passes through the first fixed portion.

### (Technical Proposal 11)

The sensor according to any one of Technical proposals 1-8, wherein
the first detection section further includes a first connecting portion provided between the first fixed portion and the first element,
the first connecting portion is supported by the first fixed portion,
the first connecting portion supports the first element,
a part of the first gap is provided between the first base region and the first connecting portion, and
a part of the first temperature detection element overlaps at least a part of the first connecting portion in the first direction.

### (Technical Proposal 12)

The sensor according to any one of Technical proposals 1-11, wherein
the second element further includes a second conductive member.

### (Technical Proposal 13)

The sensor according to any one of Technical proposals 1-12, wherein
the first temperature detection element includes a first conductive layer, and
an electrical resistance of the first conductive layer changes depending on temperature.

### (Technical Proposal 14)

The sensor according to Technical proposal 13, wherein
the first conductive layer includes at least one selected from the group consisting of a metal layer and a semiconductor.

### (Technical Proposal 15)

The sensor according to Technical proposal 13, wherein
the first conductive layer includes polysilicon.

### (Technical Proposal 16)

The sensor according to Technical proposal 13, wherein
the base includes a first circuit provided in the first base region, the first circuit including a first control element, and
the first conductive layer is electrically connected to the first control element.

### (Technical Proposal 17)

The sensor according to Technical proposal 16, wherein
the first control element includes a CMOS (Complementary Metal Oxide Semiconductor).

### (Technical Proposal 18)

The sensor according to any one of Technical proposals 1-12, wherein
the first temperature detection element includes a pn junction.

### (Technical Proposal 19)

The sensor according to any one of Technical proposals 1-12, wherein
the first temperature detection element includes a thermocouple.

### (Technical Proposal 20)

The sensor according to any one of Technical proposals 1-19, further comprising:
a first insulating film n provided between the first temperature detection element and the first element,
the first insulating film being in contact with the first temperature detection element, and
the first gap being provided between the first insulating film and the first element.

According to the embodiment, a sensor capable of highly accurate detection can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as bases, detection sections, resistance members, conductive members, temperature detection elements, circuits, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base including a first base region and a second base region;
a first detection section; and
a second detection section,
the first detection section including:
a first fixed portion fixed to the first base region,
a first temperature detection element fixed to the first base region, and
a first element supported by the first fixed portion,
a first gap being provided between the first temperature detection element and the first element,
the first element including a first resistance member and a first conductive member,
at least a part of the first temperature detection element overlapping the first element in a first direction from the first base region to the first fixed portion,
the second detection section including:
a second fixed portion fixed to the second base region, and
a second element supported by the second fixed portion,
a second gap being provided between the second base region and the second element, and
the second element including a second resistance member.

2. The sensor according to claim 1, further comprising:
a controller electrically connected to the first resistance member, the first conductive member, the second resistance member, and the first temperature detection element,
the controller being configured to perform a first operation, and
in the first operation, the controller being configured to detect a detection value corresponding to a difference between a first electrical resistance of the first resistance member after power is supplied to the first conductive member and a second electrical resistance of the second resistance member, and the controller being configured to output a first correction value obtained by correcting the detection value using a first value corresponding to a first temperature detected by the first temperature detection element.

3. The sensor according to claim 1, further comprising:
a controller electrically connected to the first resistance member, the first conductive member, the second resistance member, and the first temperature detection element,
the controller being configured to perform a first operation, and
in the first operation, the controller being configured to detect a detection value corresponding to a difference between a first electrical resistance of the first resistance member after power is supplied to the first conductive member and a second electrical resistance of the second resistance member, and the controller being configured to correct the detection value using a first value corresponding to a first temperature detected by the first temperature detection element to detect a detection target substance around the first element.

4. The sensor according to claim 1, wherein
the second detection section further includes a second temperature detection element fixed to the second base region,
the second gap is provided between the second temperature detection element and the second element, and
in the first direction, at least a part of the second temperature detection element overlaps the second element.

5. The sensor according to claim 4, further comprising:
a controller electrically connected to the first resistance member, the first conductive member, the second resistance member, the first temperature detection element, and the second temperature detection element,
the controller being configured to perform a second operation, and
in the second operation, the controller being configured to detect a detection value corresponding to a difference between a first electrical resistance of the first resistance member after power is supplied to the first conductive member and a second electrical resistance of the second resistance member, and the controller being configured to output a first correction value obtained by correcting the detection value using at least one of a first value corresponding to a first temperature detected by the first temperature detection element or a second value corresponding to a second temperature detected by the second temperature detection element.

6. The sensor according to claim 4, further comprising:
a controller electrically connected to the first resistance member, the first conductive member, the second resistance member, the first temperature detection element, and the second temperature detection element,
the controller being configured to perform a second operation,
in the second operation, the controller being configured to detect a detection value corresponding to a difference between a first electrical resistance of the first resistance member after power is supplied to the first conductive member and a second electrical resistance of the second resistance member, and the controller being configured to correct the detection value using at least one of a first value corresponding to a first temperature detected by the first temperature detection element or a second value corresponding to a second temperature detected by the second temperature detection element to detect a detection target substance around the first element.

7. The sensor according to any one of claim 4, wherein
a part of the second temperature detection element overlaps at least a part of the second fixed portion in the first direction.

8. The sensor according to claim 4, wherein
the second detection section further includes a second connecting portion provided between the second fixed portion and the second element,
the second connecting portion is supported by the second fixed portion,
the second connecting portion supports the second element,
a part of the second gap is provided between the second base region and the second connecting portion, and
a part of the second temperature detection element overlaps at least a part of the second connecting portion in the first direction.

9. The sensor according to claim 1, wherein
a part of the first temperature detection element overlaps at least a part of the first fixed portion in the first direction.

10. The sensor according to claim 9, wherein
at least one of a first resistance wiring electrically connected to the first resistance member or a first conductive wiring electrically connected to the first conductive member passes through the first fixed portion.

11. The sensor according to claim 1, wherein
the first detection section further includes a first connecting portion provided between the first fixed portion and the first element,
the first connecting portion is supported by the first fixed portion,
the first connecting portion supports the first element,
a part of the first gap is provided between the first base region and the first connecting portion, and
a part of the first temperature detection element overlaps at least a part of the first connecting portion in the first direction.

12. The sensor according to claim 1, wherein
the second element further includes a second conductive member.

13. The sensor according to claim 1, wherein
the first temperature detection element includes a first conductive layer, and
an electrical resistance of the first conductive layer changes depending on temperature.

14. The sensor according to claim 13, wherein
the first conductive layer includes at least one selected from the group consisting of a metal layer and a semiconductor.

15. The sensor according to claim 13, wherein
the first conductive layer includes polysilicon.

16. The sensor according to claim 13, wherein
the base includes a first circuit provided in the first base region, the first circuit including a first control element, and
the first conductive layer is electrically connected to the first control element.

17. The sensor according to claim 16, wherein
the first control element includes a CMOS (Complementary Metal Oxide Semiconductor).

18. The sensor according to claim 1, wherein
the first temperature detection element includes a pn junction.

19. The sensor according to claim 1, wherein
the first temperature detection element includes a thermocouple.

20. The sensor according to claim 1, further comprising:
a first insulating film provided between the first temperature detection element and the first element,
the first insulating film being in contact with the first temperature detection element, and
the first gap being provided between the first insulating film and the first element.
